(19) United States
(12) Patent Application Publication
(10) Pub. No.: US 2012/0128901 A1
(43) Pub. Date: May 24, 2012

(54) TRANSPARENT INK-JET RECORDING FILMS, COMPOSITIONS, AND METHODS

(76) Inventors: Sharon M. Simpson, Lake Elmo, MN (US); David G. Baird, Woodbury, MN (US)

(21) Appl. No.: 13/297,299

(22) Filed: Nov. 16, 2011

Related U.S. Application Data
(60) Provisional application No. 61/415,359, filed on Nov. 19, 2010.

(51) Int. Cl. B41M 5/52

(52) U.S. Cl. 428/32.15

(57) ABSTRACT

Transparent ink-jet recording films, compositions, and methods are disclosed. The compositions and methods of the present application can provide films exhibiting high maximum optical densities that are useful for medical imaging.

### CROSS REFERENCE TO RELATED APPLICATIONS

This application claims the benefit of U.S. Provisional Application No. 61/415,359, filed Nov. 19, 2010, entitled TRANSPARENT INK-JET RECORDING FILMS, COMPOSITIONS, AND METHODS, which is hereby incorporated by reference in its entirety.

### SUMMARY

Transparent ink-jet recording films often employ one or more back-coat layers on one or both sides of a transparent support. The compositions and methods of the present application can provide films exhibiting high maximum optical densities that are useful for medical imaging.

At least one embodiment provides a transparent ink-jet recording film comprising a transparent substrate comprising a polyester; at least one under-layer disposed on the transparent substrate, where the at least one under-layer comprises at least one borate or borate derivative and at least one first water soluble or water dispersible polymer comprising at least one hydroxyl group; and at least one image-receiving layer disposed on the at least one under-layer, where the at least one image-receiving layer comprises at least one inorganic particle, at least one second water soluble or water dispersible polymer, and at least one alcohol. In some embodiments, the at least one alcohol comprises at least one C1-C8 alcohol, such as, for example, n-propanol. In some embodiments, the at least one alcohol is present in an amount from about 0.5 to about 2.0 times the amount of the at least one second water soluble or water dispersible polymer, or in amount from amount from about 0.9 to about 1.8 times the amount of the at least one second water soluble or water dispersible polymer, or in amount of less than about 2.7 times the amount of the at least one second water soluble or water dispersible polymer.

These embodiments and other variations and modifications may be better understood from the detailed description, exemplary embodiments, examples, and claims that follow. Any embodiments provided are given only by way of illustrative example. Other desirable objectives and advantages inherently achieved may occur or become apparent to those skilled in the art. The invention is defined by the appended claims.

### DETAILED DESCRIPTION

All publications, patents, and patent documents referred to in this document are incorporated by reference herein in their entirety, as though individually incorporated by reference.

U.S. Provisional Application No. 61/415,359, filed Nov. 19, 2010, entitled TRANSPARENT INK-JET RECORDING FILMS, COMPOSITIONS, AND METHODS, is hereby incorporated by reference in its entirety.

### Introduction

An ink-jet recording film may comprise at least one image-receiving layer, which receives ink from an ink-jet printer during printing, and a substrate or support, which may be opaque or transparent. An opaque support may be used in films that may be viewed using light reflected by a reflective backing, while a transparent support may be used in films that may be viewed using light transmitted through the film.

### Transparent Ink-Jet Films

Transparent ink-jet recording films are known in the art. See, for example, U.S. patent application Ser. No. 13/176,788, “TRANSPARENT INK-JET RECORDING FILM,” by Simpson et al., filed Jul. 6, 2011, and U.S. patent application Ser. No. 13/208,379, “TRANSPARENT INK-JET RECORDING FILMS, COMPOSITIONS, AND METHODS,” by Simpson et al., filed Aug. 12, 2011, both of which are herein incorporated by reference in their entirety.

Transparent ink-jet recording films may comprise one or more transparent substrates. In some embodiments, the film may comprise at least one primer layer coated upon the one or more transparent substrates and at least one subbing layer coated upon the at least one primer layer. In other embodiments, the film may comprise at least one subbing layer coated upon the one or more transparent substrates. In still other embodiments, the film may comprise at least one subbing layer coated upon both the at least one primer layer and the one or more transparent substrates.

Such ink-jet recording films may further comprise at least one under-layer coated upon the at least one subbing layer. Such an under-layer may optionally be dried before being further processed. The film may further comprise one or more image-receiving layers coated upon at least one under-layer. Such an image-receiving layer is generally dried after coating. The film may optionally further comprise additional layers, such as one or more back-coat layers or overcoat layers, as will be understood by those skilled in the art.

### Transparent Substrate

Transparent substrates may be flexible, transparent films made from polymeric materials, such as, for example, polyethylene terephthalate, polyethylene naphthalate, cellulose acetate, other cellulose esters, polyvinyl acetal, polyolefins, polycarbonates, polystyrenes, and the like. In some embodiments, polymeric materials exhibiting good dimensional stability may be used, such as, for example, polyethylene terephthalate, polyethylene naphthalate, other polyesters, or polycarbonates.

Other examples of transparent substrates are transparent, multilayer polymeric supports, such as those described in U.S. Pat. No. 6,630,283 to Simpson, et al., which is hereby incorporated by reference in its entirety. Still other examples of transparent supports are those comprising dichroic mirror layers, such as those described in U.S. Pat. No. 5,795,708 to Boutet, which is hereby incorporated by reference in its entirety.

Transparent substrates may optionally contain colorants, pigments, dyes, and the like, to provide various background colors and tones for the image. For example, a blue tinting dye is commonly used in some medical imaging applications. These and other components may optionally be included in the transparent substrate, as will be understood by those skilled in the art.

In some embodiments, the transparent substrate may be provided as a continuous or semi-continuous web, which travels past the various coating, drying, and cutting stations in a continuous or semi-continuous process.

### Under-Layer Coating Mix

Under-layers may be formed by applying at least one under-layer coating mix to one or more of the subbing layers, primer layers, or transparent substrate. The under-layer coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the under-layer coating mix. In some embodiments, the water soluble or water dispersible polymer may be used in an amount of, for example, from about 0.25 to about 2.0 g/m², or from about 0.02 to about 1.8 g/m², as measured in the under-layer.

The under-layer coating mix may also optionally comprise at least one borate or borate derivative, such as, for example, sodium borate, sodium tetraborate, sodium tetraborate decahydrate, boric acid, phenyl boronic acid, butyl boronic acid, and the like. More than one type of borate or borate derivative may optionally be included in the under-layer coating mix. In some embodiments, the borate or borate derivative may be used in an amount of up to about 2 g/m². In at least some embodiments, the ratio of the at least one borate or borate derivative to the at least one water soluble or water dispersible polymer may be, for example, between about 25:75 and about 90:10 by weight, or the ratio may be about 66:33 by weight.

The under-layer coating mix may also optionally comprise other components, such as surfactants, such as, for example, nonyl phenol, glycidyl polyether. In some embodiments, such a surfactant may be used in amount from about 0.001 to about 0.10 g/m², as measured in the under-layer. These and other optional mix components will be understood by those skilled in the art.

### Image-Receiving Layer Coating Mix

Image-receiving layers may be formed by applying at least one image-receiving layer coating mix to one or more under-layer coatings. The image-receiving coating mix may comprise at least one water soluble or dispersible cross-linkable polymer comprising at least one hydroxyl group, such as, for example, poly(vinyl alcohol), partially hydrolyzed poly(vinyl acetate/vinyl alcohol), copolymers containing hydroxyethylmethacrylate, copolymers containing hydroxyethylacrylate, copolymers containing hydroxypropylmethacrylate, hydroxy cellulose ethers, such as, for example, hydroxyethylcellulose, and the like. More than one type of water soluble or water dispersible cross-linkable polymer may optionally be included in the image-receiving layer coating mix. In some embodiments, the at least one water soluble or water dispersible polymer may be used in an amount of up to about 1.0 to about 4.5 g/m², as measured in the image-receiving layer.

In some embodiments, one or more C1-C8 alcohols, such as, for example, n-propanol, may be added to the image-receiving layer coating mix. Such alcohols may be used to replace some of the water in the mix, such as, for example, about 5 wt % of the water, or about 10 wt % of the water, or about 15 wt % of the water, or about 20 wt % of the water, or about 25 wt % of the water, or about 30 wt % of the water.

The image-receiving layer coating mix may also comprise at least one inorganic particle, such as, for example, metal oxides, hydrated metal oxides, boehmite alumina, clay, calcined clay, calcium carbonate, aluminosilicates, zeolites, barium sulfate, and the like. Non-limiting examples of inorganic particles include silica, alumina, zirconia, and titania. Other non-limiting examples of inorganic particles include fumed silica, fumed alumina, and colloidal silica. In some embodiments, fumed silica or fumed alumina have primary particle sizes up to about 50 nm in diameter, with aggregates being less than about 300 nm in diameter, for example, aggregates of about 160 nm in diameter. In some embodiments, colloidal silica or boehmite alumina have particle size less than about 15 nm in diameter, such as, for example, 14 nm in diameter. More than one type of inorganic particle may optionally be included in the image-receiving coating mix.

In at least some embodiments, the ratio of inorganic particles to polymer in the at least one image-receiving layer coating mix may be, for example, between about 88:12 and about 95:5 by weight, or the ratio may be about 92:8 by weight.

Image-receiving layer coating layer mixes prepared from alumina mixes with higher solids fractions can perform well in this application. However, high solids alumina mixes can, in general, become too viscous to be processed. It has been discovered that suitable alumina mixes can be prepared at, for example, 25 wt % or 30 wt % solids, where such mixes comprise alumina, nitric acid, and water, and where such mixes comprise a pH below about 3.09, or below about 2.73, or between about 2.17 and about 2.73. During preparation, such alumina mixes may optionally be heated, for example, to 80° C.

The image-receiving coating layer mix may also comprise one or more surfactants such as, for example, a nonyl phenol, glycidyl polyether; a fluoroacrylic alcohol substituted polyethylene; a hydroxy-terminated fluorinated polyether; or a non-ionic fluorosurfactant. In some embodiments, such a surfactant may be used in amount of, for example, about 1.5 g/m², as measured in the image-receiving layer. In some embodiments, the image-receiving coating layer may also optionally comprise one or more acids, such as, for example, nitric acid.

These and components may optionally be included in the image-receiving coating layer mix, as will be understood by those skilled in the art.

### Coating

The coated layers, such as, for example, primer layers, subbing layers, under-layers, image-receiving layers, back-coat layers, overcoat layers, and the like, may be coated from mixes onto the transparent substrate. The various mixes may use the same or different solvents, such as, for example, water or organic solvents. Layers may be coated one at a time, or two or more layers may be coated simultaneously. For example, simultaneously with application of an under-layer coating mix to the support, an image-receiving layer may be applied to the wet under-layer using such methods as, for example, slide coating.

Layers may be coated using any suitable methods, including, for example, dip-coating, wound-wire rod coating, doctor blade coating, air knife coating, gravure roll coating, reverse-roll coating, slide coating, bead coating, extrusion coating, curtain coating, and the like. Examples of some coating methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety.

### Drying

Coated layers, such as, for example, primer layers, subbing layers, under-layers, image-receiving layers, back-coat layers, overcoat layers, and the like. may be dried using a variety of known methods. Examples of some drying methods are described in, for example, Research Disclosure, No. 308119, December 1989, pp. 1007-08, (available from Research Disclosure, 145 Main St., Ossining, N.Y., 10562, http://www.researchdisclosure.com), which is hereby incorporated by reference in its entirety. In some embodiments, coating layers may be dried as they travel past one or more perforated plates through which a gas, such as, for example, air or nitrogen, passes. Such an impingement air dryer is described in U.S. Pat. No. 4,365,423 to Arter et al., which is incorporated by reference in its entirety. The perforated plates in such a dryer may comprise perforations, such as, for example, holes, slots, nozzles, and the like. The flow rate of gas through the perforated plates may be indicated by the differential gas pressure across the plates. The ability of the gas to remove water may be limited by its dew point, while its ability to remove organic solvents may be limited by the amount of such solvents in the gas, as will be understood by those skilled in the art.

### EXEMPLARY EMBODIMENTS

U.S. Provisional Application No. 61/415,359, filed Nov. 19, 2010, entitled TRANSPARENT INK-JET RECORDING FILMS, COMPOSITIONS, AND METHODS, which is hereby incorporated by reference in its entirety, disclosed the following five non-limiting embodiments.

A. A transparent ink-jet recording film comprising:

a transparent substrate comprising a polyester;

at least one under-layer disposed on the transparent substrate, said at least one under-layer comprising at least one borate or borate derivative and at least one first water soluble or water dispersible polymer comprising at least one hydroxyl group; and

at least one image-receiving layer disposed on the at least one under-layer, said at least one image-receiving layer comprising at least one inorganic particle, at least second one water soluble or water dispersible polymer comprising at least one hydroxyl group, and at least one alcohol.

B. The transparent ink-jet recording film according to embodiment A, wherein the at least one alcohol comprises at least one C1-C8 alcohol.
C. The transparent ink-jet recording film according to embodiment A, where the at least one alcohol comprises n-propanol.
D. The transparent ink-jet recording film according to embodiment A, wherein the at least one alcohol is present in amount from about 0.5 to about 2.0 times the amount of the at least one second water soluble or water dispersible polymer.
E. The transparent ink-jet recording film according to embodiment A, wherein the at least one alcohol is present in an amount from about 0.9 to about 1.8 times the amount of the at least one second water soluble or water dispersible polymer.

### EXAMPLES

### Materials

Materials used in the examples were available from Aldrich Chemical Co., Milwaukee, unless otherwise specified.

Boehmite is an aluminum oxide hydroxide (γ-AlO(OH)).

Borax is sodium tetraborate decahydrate.

CELVOL® 203 is a poly(vinyl alcohol) that is 87-89% hydrolyzed, with 13,000-23,000 weight-average molecular weight. It is available from Specialty Chemicals America, Dallas, Tex.

CELVOL® 540 is a poly(vinyl alcohol) that is 87-89.9% hydrolyzed, with 140,000-186,000 weight-average molecular weight. It is available from Sekisui Specialty Chemicals America, LLC, Dallas, Tex.

DISPERAL® HP-14 is a dispersible boehmite alumina powder with high porosity and a particle size of 14 nm. It is available from Sasol North America, Inc., Houston, Tex.

Surfactant 10G is an aqueous solution of nonyl phenol, glycidyl polyether. It is available from Dixie Chemical Co., Houston, Tex.

### Example 1

Preparation of Under-Layer Coated Substrate

A nominal 15 wt % polymer solution was first made. 37.5 g of poly(vinyl alcohol) (CELVOL® 203, Sekisui) was added over ten minutes to 212.5 g of deionized water, which was agitated at room temperature. The agitated mixture was heated to 85° C. and held for 30 min. The agitated mix was cooled. After returning to room temperature, approximately 1.5 g of deionized water was added to make up for water lost to evaporation. This polymer solution was held for gas bubble disengagement prior to use.

A nominal 5 wt % borax solution was then made. 5.0 g of borax was added to 95 g of deionized water and sonicated at 47° C. This borax solution was held at 47° C. prior to use.

A sheet of polyethylene terephthalate was knife-coated with a mixture of 1.24 g of the polymer solution, 7.47 g of the borax solution, and 5.29 g of deionized water, using a wet coating gap of 4.0 mils. The resulting under-layer coating had 4 wt % solids, a weight ratio of borax to polymer of 66:33, and a dry coating weight of 1.5 g/m².

### Preparation of Image-Receiving Layer Coated Film

A nominal 10 wt % polymer solution was prepared by adding over ten minutes 25 g of poly(vinyl alcohol) (CELVOL® 540, Sekisui) to 225 g of deionized water, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 25 wt % alumina mix was prepared at room temperature by adding 9.012 g of a 22 wt % aqueous solution of nitric acid to 516.0 g of deionized water in an agitated vessel. To this mix, 175 g of alumina powder (DISPERAL® HP-14, Sasol) was added with agitation over 30 min. The pH of the mix was adjusted to 2.73 using the 22 wt % aqueous nitric acid solution. The mix was heated to 80° C. and stirred for 30 min. The mix was cooled to room temperature. This alumina mix was held for gas bubble disengagement prior to use.

A nominal 22 wt % solids image-receiving coating mix was prepared at room temperature by introducing 8.75 g of the polymer solution into a mixing vessel and agitating. To this mix, 40.25 g of the alumina mix and 0.81 g of a 10 wt % aqueous solution of nonyl phenol, glycidyl polyether were added. The resulting image-receiving layer coating mix had an inorganic particle to polymer weight ratio of 92:8.

The nominal 22 wt % solids image-receiving layer coating mix was knife-coated at room temperature onto the under-layer coated substrate, using a coating gap of 9.8 mils. The coated film was dried at 85° C. in a Blue M Oven. The image-receiving layer dry coating weight was 43 g/m².

### Evaluation of Coated Film

The coated film was then imaged with an EPSON® 4900 ink-jet printer using a Wasatch Raster Image Processor (RIP). A grey scale image was created by a combination of photo black, light black, light light black, magenta, light magenta, cyan, light cyan, and yellow EPSON® inks that were supplied with the printer. Samples were printed with a 17-step grey scale wedge having a maximum optical density of at least 2.8. The ambient relative humidity was 84-90%.

Immediately after the film exited the printer, the ink-jet image was turned over and placed over a piece of white paper. The fraction of each wedge that was wet was recorded by sequential wedge number, with wedge 1 being the wedge having the maximum optical density and wedge 17 being the wedge with the minimum optical density. In general, the higher number wedges dried before the lowest number wedges.

A measure of wetness was constructed by taking the largest wedge number for the set of completely wet wedges and adding to it the fractional wetness of the adjacent wedge with the next higher wedge number. For example, if wedges 1 and 2 were completely wet and wedge 3 was 25% wet, the wetness value would be 2.25. Or if no wedges were completely wet, but wedge 1 was 75% wet, the wetness value would be 0.75. The results are shown in Table I.

### Example 2

### Preparation of Under-Layer Coated Substrate

An under-layer coated substrate was prepared according the procedure of Example 1.

### Preparation of Image-Receiving Layer Coated Film

A nominal 10 wt % polymer solution was prepared according to the procedure of Example 1.

A nominal 30 wt % alumina mix was prepared at room temperature by adding 13.65 g of a 22 wt % aqueous solution of nitric acid to 476.35 g of deionized water in an agitated vessel. To this mix, 210 g of alumina powder (DISPERAL® HP-14, Sasol) was added with agitation over 30 min. The pH of the mix was adjusted to 2.45 using the 22 wt % aqueous nitric acid solution. The mix was heated to 80° C. and stirred for 30 min. The mix was cooled to room temperature. This alumina mix was held for gas bubble disengagement prior to use.

A nominal 26 wt % solids image-receiving coating mix was prepared at room temperature by introducing 10.11 g of the polymer solution into a mixing vessel and agitating. To this mix, 38.75 g of the alumina mix and 0.94 g of a 10 wt % aqueous solution of nonyl phenol, glycidyl polyether were added. The resulting image-receiving layer coating mix had an inorganic particle to polymer weight ratio of 92:8.

The nominal 26 wt % solids image-receiving layer coating mix was knife-coated at room temperature onto the under-layer coated substrate, using a coating gap of 8.5 mils. The coated film was dried at 85° C. in a Blue M Oven. The image-receiving layer dry coating weight was 45 g/m².

### Evaluation of Coated Film

The coated film was evaluated according to the procedure of Example 1. The results are shown in Table I.

### Example 3

### Preparation of Under-Layer Coated Substrate

An under-layer coated substrate was prepared according the procedure of Example 1.

### Preparation of Image-Receiving Layer Coated Film

A nominal 10 wt % polymer solution was prepared by adding over ten minutes 25 g of poly(vinyl alcohol) (CELVOL® 540, Sekisui) to a mixture of 202.5 g of deionized water and 22.5 g n-propanol, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 30 wt % alumina mix was prepared according to the procedure of Example 2.

A nominal 26 wt % solids image-receiving coating mix was prepared at room temperature by introducing 10.11 g of the polymer solution into a mixing vessel and agitating. To this mix, 38.75 g of the alumina mix and 0.94 g of a 10 wt % aqueous solution of nonyl phenol, glycidyl polyether were added. The resulting image-receiving layer coating mix had an inorganic particle to polymer weight ratio of 92:8.

The nominal 26 wt % solids image-receiving layer coating mix was knife-coated at room temperature onto the under-layer coated substrate, using a coating gap of 8.5 mils. The coated film was dried at 85° C. in a Blue M Oven. The image-receiving layer dry coating weight was 45 g/m².

### Evaluation of Coated Film

The coated film was evaluated according to the procedure of Example 1. The results are shown in Table I.

### Example 4

### Preparation of Under-Layer Coated Substrate

An under-layer coated substrate was prepared according the procedure of Example 1.

### Preparation of Image-Receiving Layer Coated Film

A nominal 10 wt % polymer solution was prepared by adding over ten minutes 25 g of poly(vinyl alcohol) (CELVOL® 540, Sekisui) to a mixture of 180 g of deionized water and 45 g n-propanol, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 30 wt % alumina mix was prepared according to the procedure of Example 2.

A nominal 26 wt % solids image-receiving coating mix was prepared at room temperature by introducing 10.11 g of the polymer solution into a mixing vessel and agitating. To this mix, 38.75 g of the alumina mix and 0.94 g of a 10 wt % aqueous solution of nonyl phenol, glycidyl polyether were added. The resulting image-receiving layer coating mix had an inorganic particle to polymer weight ratio of 92:8.

The nominal 26 wt % solids image-receiving layer coating mix was knife-coated at room temperature onto the under-layer coated substrate, using a coating gap of 8.5 mils. The coated film was dried at 85° C. in a Blue M Oven. The image-receiving layer dry coating weight was 45 g/m².

### Evaluation of Coated Film

The coated film was evaluated according to the procedure of Example 1. The results are shown in Table I.

### Example 5

### Preparation of Under-Layer Coated Substrate

An under-layer coated substrate was prepared according the procedure of Example 1.

### Preparation of Image-Receiving Layer Coated Film

A nominal 10 wt % polymer solution was prepared by adding over ten minutes 25 g of poly(vinyl alcohol) (CELVOL® 540, Sekisui) to a mixture of 202.5 g of deionized water and 22.5 g n-propanol, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 25 wt % alumina mix was prepared according to the procedure of Example 1.

A nominal 22 wt % solids image-receiving coating mix was prepared at room temperature by introducing 8.75 g of the polymer solution into a mixing vessel and agitating. To this mix, 40.25 g of the alumina mix and 0.81 g of a 10 wt % aqueous solution of nonyl phenol, glycidyl polyether were added. The resulting image-receiving layer coating mix had an inorganic particle to polymer weight ratio of 92:8.

The nominal 22 wt % solids image-receiving layer coating mix was knife-coated at room temperature onto the under-layer coated substrate, using a coating gap of 9.8 mils. The coated film was dried at 85° C. in a Blue M Oven. The image-receiving layer dry coating weight was 43 g/m².

### Evaluation of Coated Film

The coated film was evaluated according to the procedure of Example 1. The results are shown in Table I.

### Example 6

### Preparation of Under-Layer Coated Substrate

An under-layer coated substrate was prepared according the procedure of Example 1.

### Preparation of Image-Receiving Layer Coated Film

A nominal 10 wt % polymer solution was prepared by adding over ten minutes 25 g of poly(vinyl alcohol) (CELVOL® 540, Sekisui) to a mixture of 180 g of deionized water and 45 g n-propanol, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 25 wt % alumina mix was prepared according to the procedure of Example 1.

A nominal 22 wt % solids image-receiving coating mix was prepared at room temperature by introducing 8.75 g of the polymer solution into a mixing vessel and agitating. To this mix, 40.25 g of the alumina mix and 0.81 g of a 10 wt % aqueous solution of nonyl phenol, glycidyl polyether were added. The resulting image-receiving layer coating mix had an inorganic particle to polymer weight ratio of 92:8.

The nominal 22 wt % solids image-receiving layer coating mix was knife-coated at room temperature onto the under-layer coated substrate, using a coating gap of 9.8 mils. The coated film was dried at 85° C. in a Blue M Oven. The image-receiving layer dry coating weight was 43 g/m².

### Evaluation of Coated Film

The coated film was evaluated according to the procedure of Example 1. The results are shown in Table I.

### Example 7

### Preparation of Under-Layer Coated Substrate

An under-layer coated substrate was prepared according the procedure of Example 1.

### Preparation of Image-Receiving Layer Coated Film

A nominal 10 wt % polymer solution was prepared by adding over ten minutes 25 g of poly(vinyl alcohol) (CELVOL® 540, Sekisui) to a mixture of 157.5 g of deionized water and 67.5 g n-propanol, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 30 wt % alumina mix was prepared according to the procedure of Example 2.

A nominal 26 wt % solids image-receiving coating mix was prepared at room temperature by introducing 10.11 g of the polymer solution into a mixing vessel and agitating. To this mix, 38.75 g of the alumina mix and 0.94 g of a 10 wt % aqueous solution of nonyl phenol, glycidyl polyether were added. The resulting image-receiving layer coating mix had an inorganic particle to polymer weight ratio of 92:8.

The nominal 26 wt % solids image-receiving layer coating mix was too viscous to be knife-coated at room temperature onto the under-layer coated substrate.

### Example 8

### Preparation of Under-Layer Coated Substrate

An under-layer coated substrate was prepared according the procedure of Example 1.

### Preparation of Image-Receiving Layer Coated Film

A nominal 10 wt % polymer solution was prepared by adding over ten minutes 25 g of poly(vinyl alcohol) (CELVOL® 540, Sekisui) to a mixture of 157.5 g of deionized water and 67.5 g n-propanol, which was agitated at room temperature. The agitated mixture was heated to 85° C. and held for 30 min. The agitated mixture was cooled. After returning to room temperature, approximately 1.5 g of deionized water was added to make up for water lost to evaporation. This polymer solution was held for gas bubble disengagement prior to use.

A nominal 25 wt % alumina mix was prepared according to the procedure of Example 1.

A nominal 22 wt % solids image-receiving coating mix was prepared at room temperature by introducing 8.75 g of the polymer solution into a mixing vessel and agitating. To this mix, 40.25 g of the alumina mix and 0.81 g of a 10 wt % aqueous solution of nonyl phenol, glycidyl polyether were added. The resulting image-receiving layer coating mix had an inorganic particle to polymer weight ratio of 92:8.

The nominal 22 wt % solids image-receiving layer coating mix was too viscous to be knife-coated at room temperature onto the under-layer coated substrate.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE I

| | | | Image- | Image- | |
|---|---|---|---|---|---|
| | | | Receiving | Receiving | |
| | Alcohol to | | Layer | Layer | |
| | Polymer | Alumina | Coating | Coating | Wetness |
| ID | Wt. Ratio | Mix Solids | Mix Solids | Gap (mils) | Value |
| 1 | 0 | 25% | 22% | 9.8 | 0.5 |
| 2 | 0 | 30% | 26% | 8.5 | 0.5 |
| 3 | 0.9 | 30% | 26% | 8.5 | 0.25 |
| 4 | 1.8 | 30% | 26% | 8.5 | 0 |
| 5 | 0.9 | 25% | 22% | 9.8 | 0.5 |
| 6 | 1.8 | 25% | 22% | 9.8 | 0.125 |

What is claimed:

1. A transparent ink-jet recording film comprising:
a transparent substrate comprising a polyester;
at least one under-layer disposed on the transparent substrate, said at least one under-layer comprising at least one borate or borate derivative and at least one first water soluble or water dispersible polymer comprising at least one hydroxyl group; and
at least one image-receiving layer disposed on the at least one under-layer, said at least one image-receiving layer comprising at least one inorganic particle, at least second one water soluble or water dispersible polymer comprising at least one hydroxyl group, and at least one alcohol.

2. The transparent ink-jet recording film according to claim 1, wherein the at least one alcohol comprises at least one C1-C8 alcohol.

3. The transparent ink-jet recording film according to claim 1, where the at least one alcohol comprises n-propanol.

4. The transparent ink-jet recording film according to claim 1, wherein the at least one alcohol is present in amount from about 0.5 to about 2.0 times the amount of the at least one second water soluble or water dispersible polymer.

5. The transparent ink-jet recording film according to claim 1, wherein the at least one alcohol is present in an amount from about 0.9 to about 1.8 times the amount of the at least one second water soluble or water dispersible polymer.

6. The transparent ink-jet recording film according to claim 1, wherein the at least one alcohol is present in an amount less than about 2.7 times the amount of the at least one second water soluble or water dispersible polymer.
